(19) United States
(12) Patent Application Publication
(10) Pub. No.: US 2026/0349921 A1
(43) Pub. Date: Nov. 5, 2026

(54) PROCESSING METHOD, ARTIFICIAL INTELLIGENCE MODEL INFERENCE METHOD, AND ELECTRONIC DEVICE

(71) Applicant: Smarter Silicon (Shanghai) Technologies Co., Ltd., Shanghai (CN)

(72) Inventor: Xintao QI, Shanghai (CN)

(21) Appl. No.: 19/658,352

(22) Filed: Apr. 24, 2026

(30) Foreign Application Priority Data
Apr. 30, 2025 (CN) 202510577492.9

(51) Int. Cl. G06F 12/0802; G06N 5/04; G06F 40/30

(52) U.S. Cl. CPC G06F 12/0802; G06N 5/04; G06F 40/30; G06F 2212/60

(57) ABSTRACT

A processing method includes, when a first vector set satisfies a preset threshold, partitioning the first vector set into a plurality of consecutive vector blocks, based on a generation order of each vector pair, and sampling each vector block to obtain a second vector set, based on a global temporal position of each vector block. A vector pair includes a first vector and a second vector, the first vector is configured to identify a semantic unit, the second vector is configured to characterize semantics of the semantic unit, and the closer a temporal distance between the global temporal position corresponding to a vector block and a current generation temporal position, the greater a quantity of vector pairs sampled from the vector block. The method also includes determining an attention weight based on the first vector, and generating a new semantic unit based on the attention weight and the second vector.

### CROSS-REFERENCES TO RELATED APPLICATIONS

The present disclosure claims priority of Chinese Patent Application No. 202510577492.9, filed on Apr. 30, 2025, the entire content of which is hereby incorporated by reference.

### FIELD OF THE DISCLOSURE

The present disclosure generally relates to the field of computer technology and, more particularly, relates to a processing method, an artificial intelligence model inference method, and an electronic device.

### BACKGROUND

Nowadays, in the field of generative artificial intelligence (AI), many models employ dynamic analysis of relationships among sequence elements to generate content. However, such a generation method may subject the main memory and video memory of the hardware system to severe pressure in terms of resource utilization, and resource shortages are thus likely to occur.

### SUMMARY

One aspect of the present disclosure includes a processing method. The method includes, when a first vector set in a cache satisfies a preset threshold, partitioning, by a sampling unit, the first vector set into a plurality of consecutive vector blocks, based on a generation order of each vector pair in the first vector set, and sampling, by the sampling unit, each vector block of the plurality of consecutive vector blocks to obtain a second vector set, based on a global temporal position of each vector block of the plurality of consecutive vector blocks within an input data sequence of a target model. The first vector set include a plurality of vector pairs, a vector pair of the plurality of vector pairs includes a first vector and a second vector, the first vector is configured to identify a semantic unit within the input data sequence of the target model, the second vector is configured to characterize semantics of the semantic unit, and the closer a temporal distance between the global temporal position corresponding to a vector block of the plurality of vector blocks and a current generation temporal position, the greater a quantity of vector pairs sampled from the vector block. The method also includes determining, by an attention computation unit, an attention weight based on the first vector within the second vector set, and generating, by the attention computation unit, a new semantic unit based on the attention weight and the second vector within the second vector set. The attention weight represents a degree of association between the first vector and a generation task of the current generation temporal position.

Another aspect of the present disclosure includes an electronic device including one or more processors and a memory storing instructions that, when being executed, cause the one or more processors to perform: when a first vector set in a cache satisfies a preset threshold, partitioning, by a sampling unit, the first vector set into a plurality of consecutive vector blocks, based on a generation order of each vector pair in the first vector set, and sampling, by the sampling unit, each vector block of the plurality of consecutive vector blocks to obtain a second vector set, based on a global temporal position of each vector block of the plurality of consecutive vector blocks within an input data sequence of a target model. The first vector set include a plurality of vector pairs, a vector pair of the plurality of vector pairs includes a first vector and a second vector, the first vector is configured to identify a semantic unit within the input data sequence of the target model, the second vector is configured to characterize semantics of the semantic unit, and the closer a temporal distance between the global temporal position corresponding to a vector block of the plurality of vector blocks and a current generation temporal position, the greater a quantity of vector pairs sampled from the vector block. The method also includes determining, by an attention computation unit, an attention weight based on the first vector within the second vector set, and generating, by the attention computation unit, a new semantic unit based on the attention weight and the second vector within the second vector set. The attention weight represents a degree of association between the first vector and a generation task of the current generation temporal position.

Another aspect of the present disclosure includes an artificial intelligence model inference method. The method includes obtaining an input data sequence; based on an artificial intelligence model, processing the input data sequence to obtain a first vector set, where the first vector set includes a plurality of vector pairs, and a vector pair of the plurality of vector pairs includes a first vector and a second vector; based on a generation order of each vector pair of the plurality of vector pairs in the first vector set, partitioning the first vector set into a plurality of consecutive vector blocks, and sampling each of the plurality of consecutive vector blocks based on global temporal positions corresponding to the plurality of consecutive vector blocks within the input data sequence to obtain a second vector set, where the closer a temporal distance between a global temporal position corresponding to a vector block of the plurality of consecutive vector blocks and a current generation temporal position, the greater a quantity of vector pairs sampled from the vector block; based on the artificial intelligence model, determining an attention weight based on the first vector within the second vector set, and generating a new semantic unit based on the attention weight and the second vector within the second vector set, where the attention weight represents a degree of association between the first vector and a generation task of the current generation temporal position; and based on the artificial intelligence model and the new semantic unit, obtaining a new input data sequence.

Other aspects of the present disclosure may be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a schematic flowchart of a processing method consistent with the disclosed embodiments of the present disclosure;

FIG. 2 illustrates a schematic diagram of the interaction between an attention computation unit and a sampling unit, consistent with the disclosed embodiments of the present disclosure;

FIG. 3 illustrates a schematic diagram of an implementation scenario of a processing method consistent with the disclosed embodiments of the present disclosure;

FIG. 4 illustrates a schematic diagram of a second vector set consistent with the disclosed embodiments of the present disclosure;

FIG. 5 illustrates a schematic diagram illustrating a variation in computational complexity or power consumption, consistent with the disclosed embodiments of the present disclosure;

FIG. 6 illustrates a schematic diagram of another implementation scenario of a processing method consistent with the disclosed embodiments of the present disclosure;

FIG. 7 illustrates a schematic diagram of another implementation scenario of a processing method consistent with the disclosed embodiments of the present disclosure;

FIG. 8 illustrates a schematic diagram of another implementation scenario of a processing method consistent with the disclosed embodiments of the present disclosure;

FIG. 9 illustrates a schematic diagram of another implementation scenario of a processing method consistent with the disclosed embodiments of the present disclosure;

FIG. 10 illustrates a schematic flowchart of another processing method consistent with the disclosed embodiments of the present disclosure;

FIG. 11 illustrates a schematic flowchart of another processing method consistent with the disclosed embodiments of the present disclosure; and

FIG. 12 illustrates a schematic diagram illustrating a time perspective of a processing method consistent with the disclosed embodiments of the present disclosure.

### DETAILED DESCRIPTION

To make the objectives, technical solutions and advantages of the present disclosure more clear and explicit, the present disclosure is described in further detail with accompanying drawings and embodiments. It should be understood that the specific exemplary embodiments described herein are only for explaining the present disclosure and are not intended to limit the present disclosure.

It should be noted that in the present disclosure, relational terms such as “first” and “second” are only configured to distinguish one entity or operation from another entity or operation, and do not necessarily require or imply that such actual relationship or sequence exists between these entities or operations. Terms “include”, “include” or any other variations thereof are intended to cover a non-exclusive inclusion. A process, method, article, or apparatus that includes a series of elements includes not only the series of elements, but also other elements not expressly listed, or elements inherent to such a process, method, article, or apparatus. Without further limitation, an element defined by a statement like “includes a...” does not exclude the presence of additional identical elements in a process, method, article, or apparatus that includes the foregoing element.

It should be noted that relative arrangements of components and operations, numerical expressions and numerical values set forth in exemplary embodiments are for illustration purposes only and are not intended to limit the present disclosure unless otherwise specified. Techniques, methods and apparatus known to the skilled in the relevant art may not be discussed in detail, but these techniques, methods and apparatus should be considered as a part of the specification, where appropriate.

In the field of artificial intelligence (AI), models are core components for accomplishing various intelligent tasks. As an important branch in the field of artificial intelligence, generative models are dedicated to learning the underlying distribution of data, and may be capable of generating new samples similar to the training data.

Popular generative models may include but are not limited to Generative Language Models (GLMs), Text-to-Image Models, and Expert Models. The Generative Language Models, such as Large Language Models (LLMs) like the GPT series and LLaMA, may generate coherent text using an autoregressive approach. The Text-to-Image Models, such as Stable Diffusion and the DALL-E series, may transform textual descriptions into high-quality images through a diffusion process. The Text-to-Image Generation Models, such as Florence and KOSMOS, may be capable of cross-modal content generation and understanding. The Expert Models are vertical-domain models derived from general-purpose large models through fine-tuning with domain-specific data, such as medical diagnosis models, legal document generation models, and the like.

A common characteristic shared by above models is the adoption of the attention mechanism from the transformer architecture. During the attention computation process, generative AI models may employ Query-Key-Value (QKV) triplets to perform contextual modeling, resulting in a computational complexity that increases with the length of the sequence. When handling long-text generation (such as document creation) or high-resolution image generation, issues regarding video memory consumption and computational latency may be pronounced.

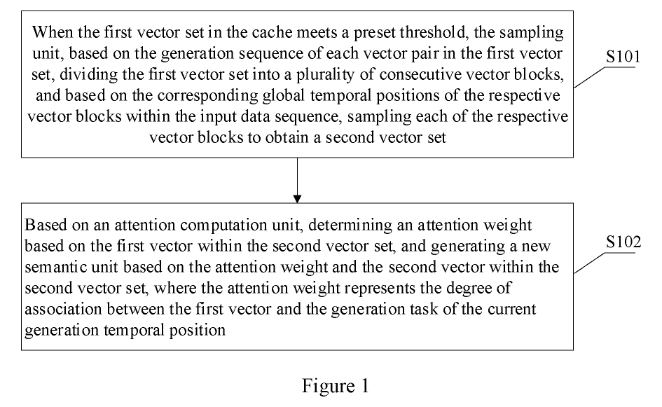

The present disclosure provides a processing method. FIG. 1 illustrates a schematic flowchart of a processing method consistent with the disclosed embodiments of the present disclosure. Referring to FIG. 1, the processing method may include, but is not limited to, S101 and S102.

S101: when the first vector set in the cache meets a preset threshold, the sampling unit, based on the generation sequence of each vector pair in the first vector set, dividing the first vector set into a plurality of consecutive vector blocks, and based on the corresponding global temporal positions of the respective vector blocks within the input data sequence, sampling each of the respective vector blocks to obtain a second vector set.

The first vector set may include a plurality of vector pairs including a first vector and a second vector. The first vector may be used to identify a semantic unit (e.g., character, word, phrase, syntactic fragment, etc.) within an input data sequence of a target model. The second vector may be used to characterize the semantics of the semantic unit.

In one embodiment, each semantic unit in the input data sequence may be processed based on an artificial intelligence model to generate a vector pair corresponding to the semantic unit. A vector pair includes a first vector and a second vector. The generation order of vector pairs remains consistent with the order in which individual semantic units appear within the input data sequence (i.e., the global temporal positions).

When actually stored in the cache, the vector pairs may be stored contiguously in the form of a single vector matrix, in the order in which the vector pairs are generated. For example, the input data sequence may include "I Love Natural Language Processing". The corresponding individual semantic units may include: ["I", "Love", "Natural", "Language", "Processing"], where the temporal position t of each semantic unit ranges from 0 to 4.

When processing "I" (at t=0), the AI model generates k_0 and v_0, and stores k_0 and v_0 in cache[0]. When processing "Love" (t=1), the AI model generates k_1 and v_1 and stores k_1 and v_1 in cache[1], and so on. Specifically, the cache[0] represents the 0th column of the cache, and cache[1] represents the 1st column of the cache. The column indices in the cache matrix represent the generation order of the vector pairs, aligning with the temporal positions of the corresponding semantic units. The row indices in the cache matrix represent the dimensions of the vector pairs.

When actually stored in the cache, each first vector may also be stored contiguously as an independent first vector matrix (which may be represented as K_cache). Matrix dimensions may be represented as [M, D_K], where M denotes the number of the first vectors, and D_K denotes the dimension of the first vectors. Each second vector may also be synchronously and contiguously stored as another independent second vector matrix (which may be represented as V_cache). The dimensions of the matrix may be represented as [M, D_V], where M denotes the number of second vectors and D_V denotes the dimension of the second vectors. The number of the first vectors and the second vectors may be consistent, and the dimensions of the first vectors and second vectors may be consistent.

For example, the input data sequence may include "I Love Natural Language Processing". The corresponding individual semantic units may include: ["I", "Love", "Natural", "Language", "Processing"], with the temporal position t of each semantic unit ranging from 0 to 4. When processing "I" (at t=0), the AI model generates k_0 and v_0, and stores k_0 and v_0 in K_cache[0] and V_cache[0]. When processing "Love" (t=1), the AI model generates k_1 and v_1, and stores k_1 and v_1 in K_cache[1] and V_cache[1], and so on. Specifically, K_cache[0] represents the 0th column of K_cache, and V_cache[0] represents the 0th column of V_cache. K_cache[1] represents the first column of K_cache, and V_cache[1] represents the first column of V_cache.

The column indices in the K_cache matrix may represent the generation order of the first vectors, aligning with the temporal positions of the corresponding semantic units. The row indices in the K_cache matrix may represent the dimension of the first vector. Correspondingly, the column indices in the V_cache matrix may represent the generation order of the second vectors, aligning with the temporal positions of the corresponding semantic units. The row indices in the V_cache matrix may represent the dimension of the second vector.

As a user inputs more suggestion words, the quantity of vector pairs may increases rapidly. Directly processing each vector pair may result in a substantial surge in computational workload and a drastic increase in computational complexity, potentially exceeding the hardware's maximum processing capacity and triggering computational delays, or even system crashes. By dividing the first vector set into vector blocks using sampling units and sampling based on global temporal positions, a second vector set with a smaller size than the first vector set may be obtained. Accordingly, the quantity of vector pairs that need to be calculated in subsequent processing may be reduced, and the computational complexity may thus be reduced. Accordingly, the attention computation unit may complete computation tasks within a reasonable timeframe, and computational efficiency may thus be improved.

In addition, storing a large quantity of vector pairs in the cache may consume significant main memory and video memory resources. As the quantity of vectors increases, main memory and video memory usage may continuously climb, and the normal operation of other tasks may be disrupted. By the sampling operation, vector pairs may be filtered, retaining only a subset to form a second vector set, and the quantity of vector pairs stored in the cache may thus be reduced. Accordingly, the main memory and video memory usage may be reduced, providing more space for execution of other tasks and enhancing the overall performance and stability of attention computation.

In one embodiment, the minimum global temporal position in the individual vector pairs within each vector block may be, though not exclusively, designated as the global temporal position corresponding to that vector block. For example, in the example "I Love Natural Language Processing", the first vector set may be divided into two consecutive vector blocks, namely Vector Block 1 and Vector Block 2. Vector Block 1 may contain a vector pair consisting of k_0 and v_0, a vector pair consisting of k_1 and v_1, and a vector pair consisting of k_2 and v_2. Vector Block 2 may contain a vector pair consisting of k_3 and v_3, and a vector pair consisting of k_4 and v_4. The generation order of the vector pairs consisting of k_0 and v_0 in vector block 1 (i.e., the smallest global temporal position in vector block 1) may be designated as the global temporal position corresponding to vector block 1. The generation order of the vector pair consisting of k_3 and v_3 within Vector Block 2 (i.e., the earliest global temporal position within Vector Block 2) may be designated as the global temporal position corresponding to Vector Block 2.

In one embodiment, the AI model may predict a new semantic unit at the current generation temporal position. For example, in the example "I Love Natural Language Processing", the temporal position t of each semantic unit, namely ["I", "Love", "Natural", "Language", "Processing"], ranges from 0 to 4. When the current generation temporal position is t=5, the AI model is predicting a 6th semantic unit.

The closer the temporal distance between the global temporal position corresponding to the vector block and the current generation temporal position, the greater the quantity of vector pairs sampled from the vector block. For example, in the examples of Vector Block 1 and Vector Block 2 above, the temporal distance between the global temporal position corresponding to Vector Block 2 (i.e., t=3) and the current generation temporal position (i.e., t=5) is closer than the temporal distance between the global temporal position corresponding to Vector Block 1 (i.e., t=0) and the current generation temporal position (i.e., t=5). Each vector pair within Vector Block 2 may be sampled, while one or two vector pairs within Vector Block 1 may be sampled.

The preset threshold may be configured as needed and is not limited in the present disclosure.

S102: based on an attention computation unit, determining an attention weight based on the first vector within the second vector set, and generating a new semantic unit based on the attention weight and the second vector within the second vector set. The attention weight represents the degree of association between the first vector and the generation task of the current generation temporal position.

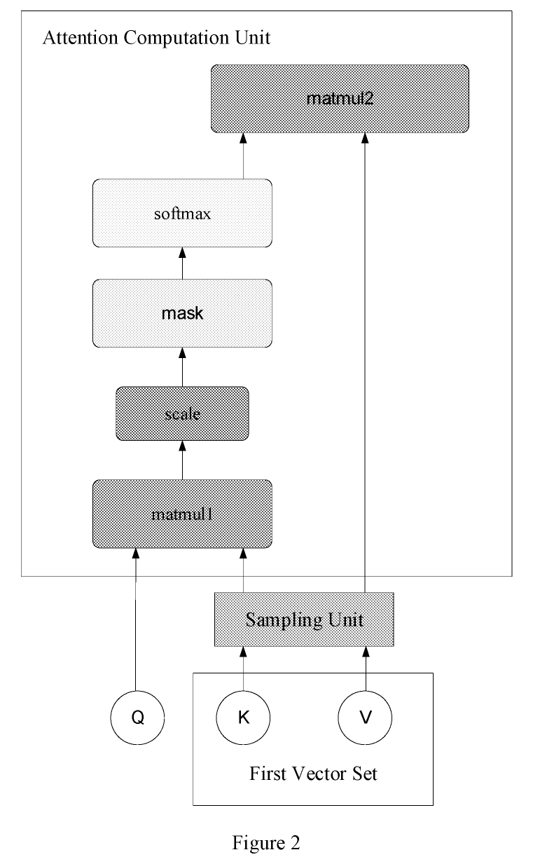

FIG. 2 illustrates a schematic diagram of the interaction between an attention computation unit and a sampling unit, consistent with the disclosed embodiments of the present disclosure. In one embodiment, as shown in FIG. 2, the sampling unit may pass the second vector set to the attention computation unit. The attention computation unit may determine the attention weight based on the first vector (which may be represented as K) in the second vector set, and generate a new semantic unit based on the attention weight and the second vector (which may be represented as V) in the second vector set.

The process for generating a new semantic unit may include, but is not limited to, matmul1 - performing a dot product operation between the query vector (denoted as Q) and each of the first vectors within the second vector set, yielding initial attention weights; scale - scaling the initial attention weight to obtain a scaled attention weight; mask - applying a mask to the scaled attention weight to obtain a masked attention weight; softmax - normalizing the masked attention weight to obtain an attention weight; and matmul2 - performing a dot product operation between the attention weight and each vector in the second vector set, yielding a weighted-fused vector. The weighted-fused vector may be used to predict a new semantic unit.

As shown in FIG. 2, in one embodiment, no modifications are made to the attention computation unit. The sampling unit and the attention computation unit may operate independently while remaining compatible for interconnection. Since the internal logic of the attention computation unit remains unaltered, the execution logic of the sampling unit may flexibly adapt to the execution framework of the attention computation unit.

It should be noted that the sampling unit does not operate continuously. The sampling unit may initiate execution based on a specific trigger condition. In one embodiment, the trigger condition may include, but is not limited to, the first vector set in the cache meeting a preset threshold.

In one embodiment, when the first vector set in the cache meets a preset threshold, based on the generation order of each vector pair in the first vector set, the sampling unit divides the first vector set into a plurality of consecutive vector blocks. Furthermore, based on the global temporal positions corresponding to the respective vector blocks within the input data sequence, the vector blocks each are sampled to obtain a second vector set. During the sampling process, the closer the temporal distance between the global temporal position corresponding to the vector block and the current generation temporal position, the greater the quantity of the vector pairs sampled from the vector block. In this way, the quantity of vector pairs in the second vector set may be smaller than the quantity of vector pairs in the first vector set, while the complete loss of local information may be prevented. In addition, the vector pairs within the vector blocks, which exhibit a close temporal distance to the current generation temporal position, may be retained to a greater extent.

With the attention computation unit, the attention weight may be determined according to the first vector in the second vector set, and a new semantic unit may be generated based on the attention weight and the second vector in the second vector set. As such, the computational complexity of the attention computation may be reduced, and the main memory and video memory usage, as well as computation time may be lowered. Also, since the complete loss of local information may be avoided during the sampling process, the attention computation process may prevent the occurrence of semantic discontinuity.

In addition, since more vector pairs are retained during the sampling process for the vector block that is temporally close to the current generation temporal position, the attention computation process may capture local contextual information that has a greater impact on the generation task of the current generation temporal position. As such, the new semantic unit generated at the current generation temporal position may have high accuracy, as well as good logical coherence among the semantic units. Accordingly, the accuracy of the inference process may be maintained, and potential precision loss that may arise from sampling operations may be prevented.

As another optional embodiment of the present disclosure, Embodiment 2 of the present disclosure is mainly an implementation method for sampling each vector block based on the global temporal position corresponding to each vector block in the input data sequence. Specifically, Embodiment 2 may include, but is not limited to, S11, S12 and S13.

S11: assigning an initial sampling ratio to the target vector block that has the closest temporal distance between the global temporal position and the current generation temporal position, among the vector blocks. The initial sampling ratio may be set as needed and is not limited in the present disclosure. For example, the initial sampling ratio may be 100%. That is, each vector pair within the target vector block is sampled.

S12: as the difference between the global temporal position of each of the other vector blocks and the target vector block increases, decreasing the sampling ratio from the initial sampling ratio to obtain the sampling ratios for the other vector blocks. The way of decrease may be configured as needed and is not limited in the present disclosure.

S13: sampling each of the vector blocks based on the sampling ratio of each vector block. By sampling each of the vector blocks based on the respective sampling ratios, the quantity of sampled vector pairs within each vector block may meet the sampling ratios.

In one embodiment, the target vector block is more critical to the generation task of the current generation temporal position. By assigning the initial sampling ratio for target vector block, the integrity of critical information during sampling may be maintained. As such, the attention computation process may capture local contextual information that directly influences current inference, and the inference accuracy may be improved. Despite having a lower degree of relevance to the current task compared to the target vector block, other vector blocks may still provide auxiliary information. By employing a reduced sampling ratio, a portion of historical information may be preserved to maintain semantic coherence, while redundant computation may be minimized.

As another optional embodiment of the present disclosure, Embodiment 3 of the present disclosure is mainly an implementation of S12 described above. S12 may include, but is not limited to, S121: as the difference between the global temporal position of each of the other vector blocks and the target vector block increases, linearly decreasing the sampling ratio, starting from the initial sampling ratio.

In one embodiment, the linearly decreasing process may be implemented using a fixed decrement strategy. Specifically, during each decrement operation, the sampling ratio of the current vector block may be reduced by a fixed decrement amount relative to the sampling ratio of an adjacent vector block of the current vector block in the global temporal position. For example, at the current generation temporal position t=400, the first vector set includes 400 vector pairs. The first vector set may be partitioned into four consecutive vector blocks, denoted as Vector Block 1, Vector Block 2, Vector Block 3, and Vector Block 4, respectively. The global temporal position corresponding to Vector Block 1 is T0=0; the global temporal position corresponding to Vector Block 2 is T1=100; the global temporal position corresponding to Vector Block 3 is T2=200; and the global temporal position corresponding to Vector Block 4 is T3=300. The temporal distance between the global temporal position corresponding to Vector Block 4 and the current generation temporal position is the shortest. That is, the target vector block may be Vector Block 4.

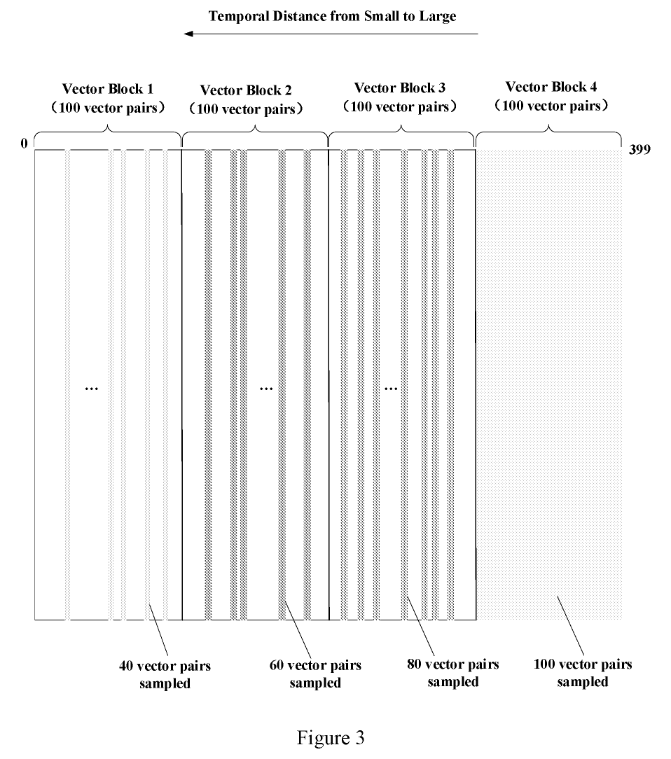

FIG. 3 illustrates a schematic diagram of an implementation scenario of a processing method consistent with the disclosed embodiments of the present disclosure. As shown in FIG. 3, Vector Block 1 includes vector pairs ranging from global temporal position t=0 to global temporal position t=99 (totaling 100 pairs); Vector Block 2 includes vector pairs ranging from global temporal position t=100 to global temporal position t=199 (totaling 100 pairs); Vector Block 3 includes vector pairs ranging from global temporal position t=200 to global temporal position t=299 (totaling 100 pairs); and Vector Block 4 includes vector pairs ranging from global temporal position t=300 to global temporal position t=399 (totaling 100 pairs).

In one embodiment, the initial sampling ratio for Vector Block 4 is 100%, meaning that each of the 100 vector pairs within Vector Block 4 is sampled. The fixed decrement is 20%. As such, for Vector Block 3, the sampling ratio decreases linearly from 100% to 80%, meaning that 80 vector pairs are sampled. For Vector Block 2, the sampling ratio decreases linearly from 80% to 60%, meaning that 60 vector pairs are sampled. For Vector Block 1, the sampling ratio decreases linearly from 60% to 40%, meaning that 40 vector pairs are sampled.

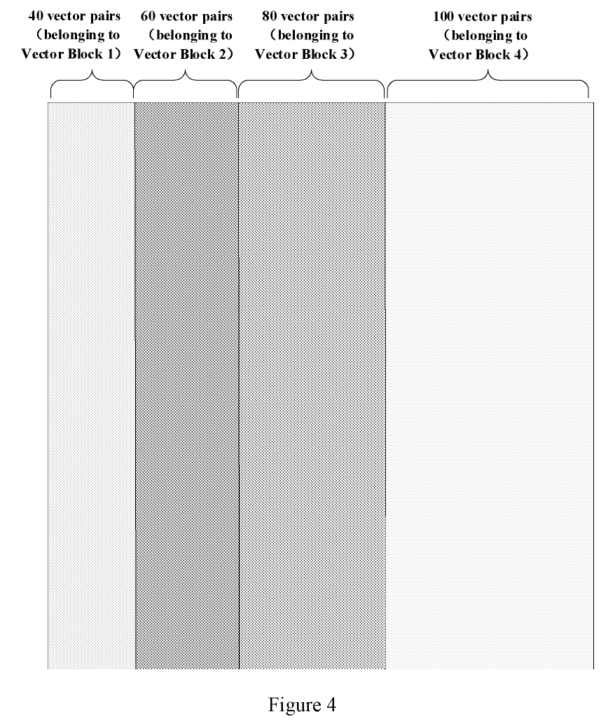

FIG. 4 illustrates a schematic diagram of a second vector set consistent with the disclosed embodiments of the present disclosure. As shown in FIG. 4, the quantity of vector pairs in the second vector set is 280. Compared to the first vector set, the quantity of vector pairs in the second vector set is reduced, thereby lowering the computational load in subsequent operations.

It should be noted that FIGS. 3 and 4 are merely visual examples of the first and second vector sets, to visually illustrate the partitioning of vector blocks, the temporal distance between global temporal positions and the current generation temporal position, and the logical relationship of a decreasing sampling ratio. FIGS. 3 and 4 constitute no restrictive constraint whatsoever upon the storage architecture, physical layout, or data organization form of the first vector set in an actual caching system.

In one embodiment, as the difference between the global temporal positions of other vector blocks and the target vector block increases, the sampling ratio of the target vector block decreases linearly, thus maintaining the smoothness of the data volume change of the sampled vector pairs. Accordingly, while computational complexity is reduced, the vector pairs are preserved as many as possible to maintain the accuracy and coherence of the newly generated semantic units.

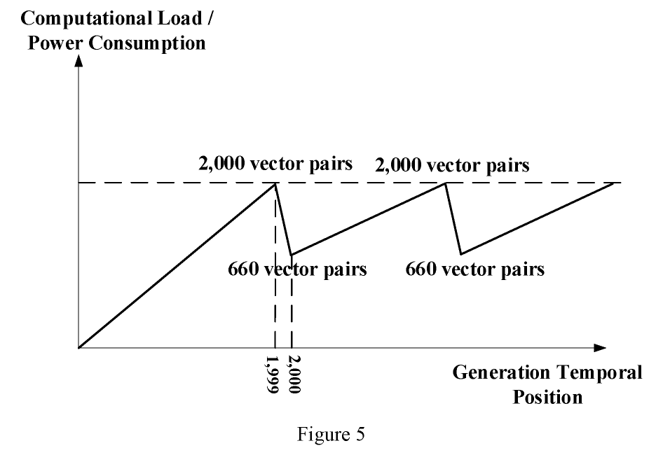

FIG. 5 illustrates a schematic diagram illustrating a variation in computational complexity or power consumption, consistent with the disclosed embodiments of the present disclosure. In one embodiment, as shown in FIG. 5, from the perspective of generation temporal positions, the quantity of vector pairs increases continuously as the input data sequence is continuously processed. When the quantity of vector pairs reaches 2,000 (i.e., at generation temporal position t=1999), the computational load or power consumption reaches a peak, and sampling is triggered. The sampling unit may sample 660 vector pairs from 2,000 vector pairs. As the generation temporal position advances to t=2000, the attention computation unit may perform attention computations based on the 660 sampled vector pairs. Compared to performing the attention computations directly on the full set of 2,000 vector pairs, the computational load is significantly reduced. After the initiation of sampling, as new semantic units are continuously generated, the quantity of vector pairs may once again begin to gradually accumulate. Although the growth rate of computational load may be slow compared to the unsampled approach, the overall computational load may nonetheless rise gradually as the generation temporal position progresses. However, the power consumption throughout the entire process may not exceed the peak described above.

It should be noted that the trends in computational load or power consumption illustrated in FIG. 5 are presented solely as an example and do not constitute a limitation or constraint on the actual variations of the computational load or power consumption.

As another optional embodiment of the present disclosure, Embodiment 4 is a specific implementation of S12. S12 may include, but is not limited to, S122: as the difference between the global temporal positions of each of the other vector blocks and the target vector block increases, decreasing the sampling ratio non-linearly, starting from the initial sampling ratio.

In one embodiment, nonlinear decrease may include, but is not limited to, exponential decrease.

Non-linear decrease may also include, but is not limited to: performing decrementing by varying decrement amounts based on the differences between the global temporal positions of other vector blocks and the target vector block. For example, at the current generation temporal position t=2000, the first vector set includes 2,000 vector pairs. The first vector set may be partitioned into four consecutive vector blocks, denoted as Vector Block 1, Vector Block 2, Vector Block 3, and Vector Block 4, respectively. The global temporal position corresponding to Vector Block 1 is T0=0; the global temporal position corresponding to Vector Block 2 is T1=500; the global temporal position corresponding to Vector Block 3 is T2=1000; and the global temporal position corresponding to Vector Block 4 is T3=1500. The temporal distance between the global temporal position corresponding to Vector Block 4 and the current generation temporal position is the shortest. That is, the target vector block may be Vector Block 4.

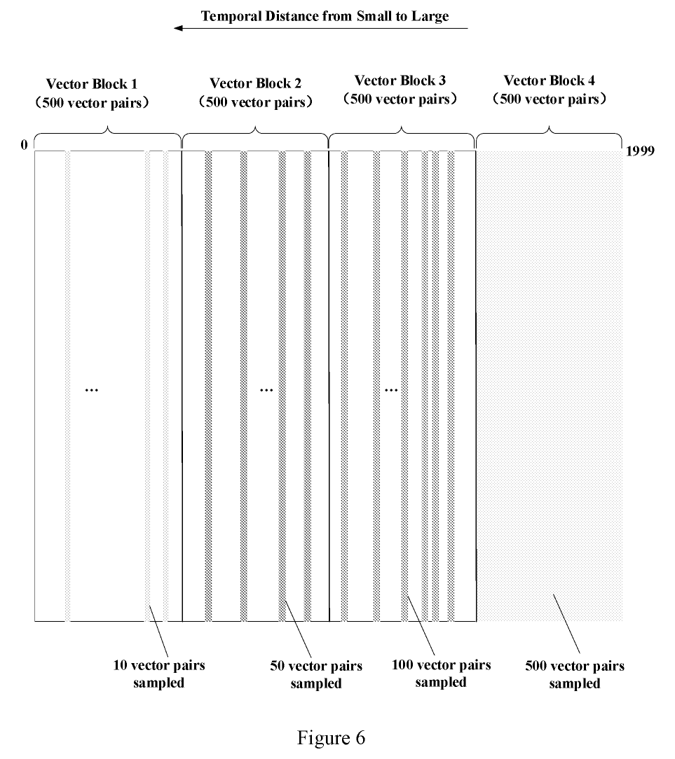

FIG. 6 illustrates a schematic diagram of another implementation scenario of a processing method consistent with the disclosed embodiments of the present disclosure. In one embodiment, as shown in FIG. 6, Vector Block 1 includes vector pairs ranging from global temporal position t=0 to global temporal position t=499 (totaling 500 pairs); Vector Block 2 includes vector pairs ranging from global temporal position t=500 to global temporal position t=999 (totaling 500 pairs); Vector Block 3 includes vector pairs ranging from global temporal position t=1000 to global temporal position t=1499 (totaling 500 pairs); and Vector Block 4 includes vector pairs ranging from global temporal position t=1500 to global temporal position t=1999 (totaling 500 pairs).

The initial sampling ratio for Vector Block 4 is 100%, that is, the 500 vector pairs within Vector Block 4 each are sampled. For Vector Block 3, the sampling ratio decreases from 100% to 20%, meaning that 100 vector pairs are sampled. For Vector Block 2, the sampling ratio decreases from 20% to 10%, meaning that 50 vector pairs are sampled. For Vector Block 1, the sampling ratio decreases from 10% to 2%, meaning that 10 vector pairs are sampled.

As such, the second vector set includes 660 vector pairs, representing an obvious reduction in the quantity of vector pairs compared to the first vector set.

It should be noted that FIG. 6 serves merely as a visualization example of the first vector set, intended to intuitively illustrate the partitioning of vector blocks, the temporal distance between global temporal positions and the current generation temporal position, and the logical relationship of the decreasing sampling ratio. FIG. 6 does not constitute any limiting constraint regarding the storage architecture, physical layout, or data organization form of the first vector set within an actual caching system.

In one embodiment, as the difference between the global temporal positions of other vector blocks and the target vector block increases, the sampling ratio decreases non-linearly from the initial sampling ratio. As such, the computational complexity may be reduced, particularly when the first vector set is large, while the inference accuracy may be maintained, and potential precision loss resulting from sampling operations may be avoided.

As another optional embodiment of the present disclosure, Embodiment 5 is a specific implementation of S13. S13 may include, but is not limited to, S131 and S132.

S131: determining, for each vector pair within each of the vector blocks, the intra-block temporal distance between the global temporal position corresponding to the vector pair and the current generation temporal position. For each of the vector blocks, the absolute value of the difference between the global temporal position corresponding to each vector pair within the block and the current generation temporal position may be defined as the intra-block temporal distance of the vector pair.

S132: within a same vector block, by comparing the value of the intra-block temporal distance for each of the vector pairs, performing sampling, starting from the vector pair with the minimum intra-block temporal distance, at a preset sampling interval, until the quantity of the sampled vector pairs reaches the specified sampling ratio for the vector block. The sampling interval may be set as required and is not limited in the present disclosure.

In one embodiment, the sampling interval is set to 1. That is, sampling is continuously performed within the vector block. For example, at the current generation temporal position t=400, the first vector set includes 400 vector pairs. The first vector set may be partitioned into four consecutive vector blocks, denoted as Vector Block 1, Vector Block 2, Vector Block 3, and Vector Block 4, respectively. The global temporal position corresponding to Vector Block 1 is T0=0; the global temporal position corresponding to Vector Block 2 is T1=100; the global temporal position corresponding to Vector Block 3 is T2=200; and the global temporal position corresponding to Vector Block 4 is T3=300. The temporal distance between the global temporal position corresponding to Vector Block 4 and the current generation temporal position is the shortest. That is, the target vector block may be Vector Block 4.

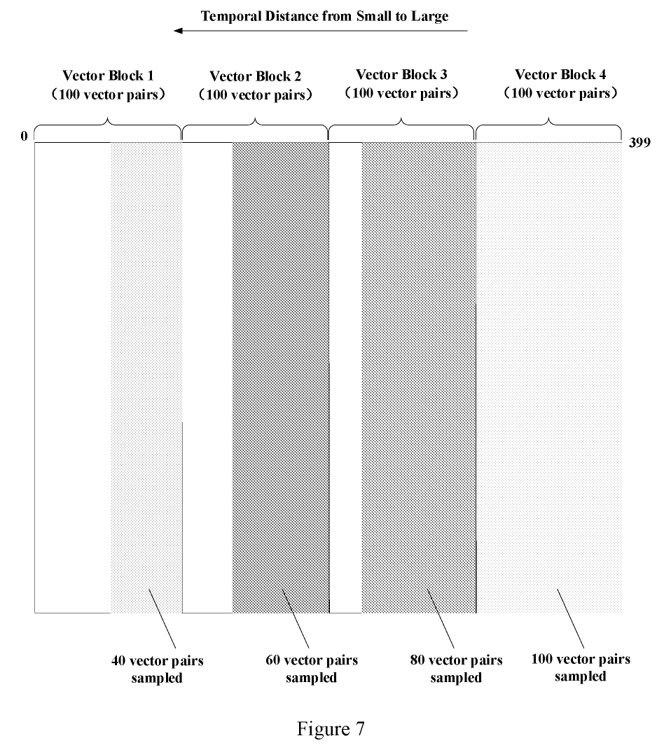

FIG. 7 illustrates a schematic diagram of another implementation scenario of a processing method consistent with the disclosed embodiments of the present disclosure. In one embodiment, as shown in FIG. 7, Vector Block 1 includes vector pairs ranging from global temporal position t=0 to global temporal position t=99 (totaling 100 pairs); Vector Block 2 includes vector pairs ranging from global temporal position t=100 to global temporal position t=199 (totaling 100 pairs); Vector Block 3 includes vector pairs ranging from global temporal position t=200 to global temporal position t=299 (totaling 100 pairs); and Vector Block 4 includes vector pairs ranging from global temporal position t=300 to global temporal position t=399 (totaling 100 pairs).

The initial sampling ratio for Vector Block 4 is 100%. That is, the quantity of vector pairs to be sampled in Vector Block 4 is 100. Within Vector Block 4, sampling is performed continuously, starting from the vector pair at t=399 and continuing until the vector pair at t=300 is sampled.

For Vector Block 3, the sampling ratio decreases linearly from 100% to 80%. Specifically, the quantity of vector pairs to be sampled within Vector Block 3 amounts to 80. Within Vector Block 3, sampling is performed consecutively, starting from the vector pair at t=299 and continuing until the vector pair at t=220 is sampled.

For Vector Block 2, the sampling ratio decreases linearly from 80% to 60%. Specifically, the quantity of vector pairs to be sampled within Vector Block 2 amounts to 60. Within Vector Block 2, sampling is performed continuously, starting from the vector pair at t=199 and proceeding until the vector pair at t=140 is sampled.

For Vector Block 1, the sampling ratio decreases linearly from 60% to 40%. Specifically, the quantity of vector pairs to be sampled within Vector Block 1 amounts to 40. Within Vector Block 1, sampling is performed consecutively, starting from the vector pair at t=99 and continuing until the vector pair at t=60 is sampled.

For another example, when the current generation temporal position is t=2000, the first vector set includes 2,000 vector pairs. The first vector set may be partitioned into four consecutive vector blocks, denoted as Vector Block 1, Vector Block 2, Vector Block 3, and Vector Block 4, respectively. The global temporal position corresponding to Vector Block 1 is T0=0; the global temporal position corresponding to Vector Block 2 is T1=500; the global temporal position corresponding to Vector Block 3 is T2=1000; and the global temporal position corresponding to Vector Block 4 is T3=1500. The temporal distance between the global temporal position corresponding to Vector Block 4 and the current generation temporal position is the shortest. That is, the target vector block may be Vector Block 4.

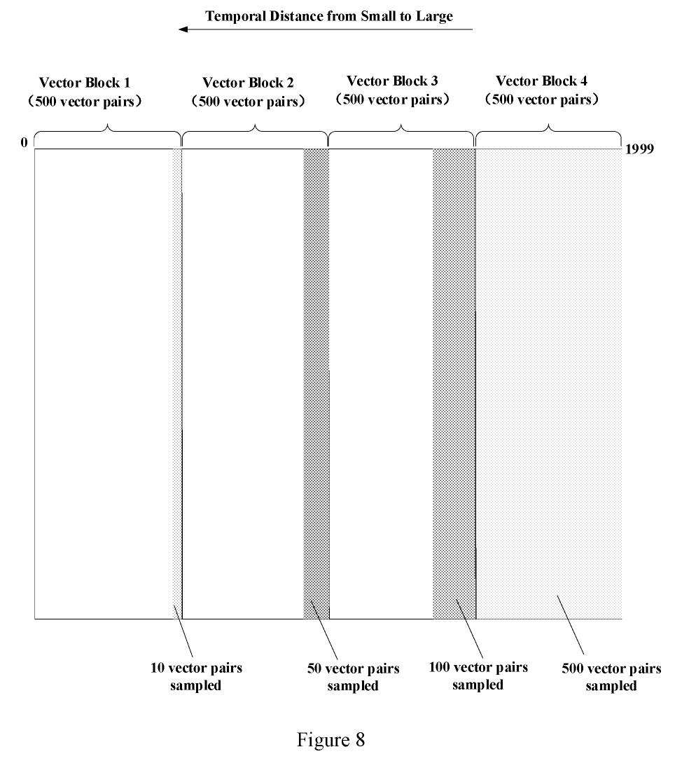

FIG. 8 illustrates a schematic diagram of another implementation scenario of a processing method consistent with the disclosed embodiments of the present disclosure. In one embodiment, as shown in FIG. 8, Vector Block 1 includes vector pairs corresponding to global temporal positions t=0 through t=499 (totaling 500 pairs); Vector Block 2 includes vector pairs corresponding to global temporal positions t=500through t=999 (totaling 500 pairs); Vector Block 3 includes vector pairs ranging from global temporal position t=1000 to global temporal position t=1499 (totaling 500 pairs); and Vector Block 4 includes vector pairs ranging from global temporal position t=1500 to global temporal position t=1999 (totaling 500 pairs).

The initial sampling ratio for Vector Block 4 is 100%. That is, the quantity of vector pairs to be sampled within Vector Block 4 is 500. Within Vector Block 4, sampling is performed continuously, starting from the vector pair at t=1999 and continuing until the vector pair at t=1500 is sampled.

For Vector Block 3, the sampling ratio decreases from 100% to 20%. Specifically, the quantity of vector pairs to be sampled within Vector Block 3 is 100. Within Vector Block 3, sampling is performed continuously, starting from the vector pair at t=1499 and continuing until the vector pair at t=1400 is sampled.

For Vector Block 2, the sampling ratio decreases from 20% to 10%. Specifically, the quantity of vector pairs to be sampled within Vector Block 2 is 50. Within Vector Block 2, continuous sampling is performed, starting from the vector pair at t=999 and continuing until the vector pair at t=950 is sampled.

For Vector Block 1, the sampling ratio decreases from 10% to 2%. Specifically, the quantity of vector pairs to be sampled within Vector Block 1 is 10. Within Vector Block 1, continuous sampling is performed, starting from the vector pair at t=499 and continuing until the vector pair at t=490 is sampled.

In one embodiment, vector pairs with smaller intra-block temporal distances typically contain more crucial contextual information for the current generation task. The intra-block temporal distance between the global sequencing positions corresponding to each vector pair in each vector block and the current generation temporal position may be determined. Within a same vector block, by comparing the value of the intra-block temporal distance of each vector pair, sampling is performed starting from the vector pair with the smallest intra-block temporal distance at a set sampling interval until the number of sampled vector pairs reaches the sampling ratio of the vector block. In this way, more vector pairs within the vector blocks that are temporally close to the current generation temporal position may be retained, and the sampling within the vector blocks may also prioritize retaining the vector pairs that are more relevant to the generation task of the current generation temporal position. Accordingly, while computational complexity may be reduced, inference accuracy may be improved.

As another optional embodiment of the present disclosure, Embodiment 6 is a specific implementation of S13. S13 may include, but is not limited to, S133: based on the sampling ratios of the vector blocks, randomly sampling vector pairs within each of the vector blocks.

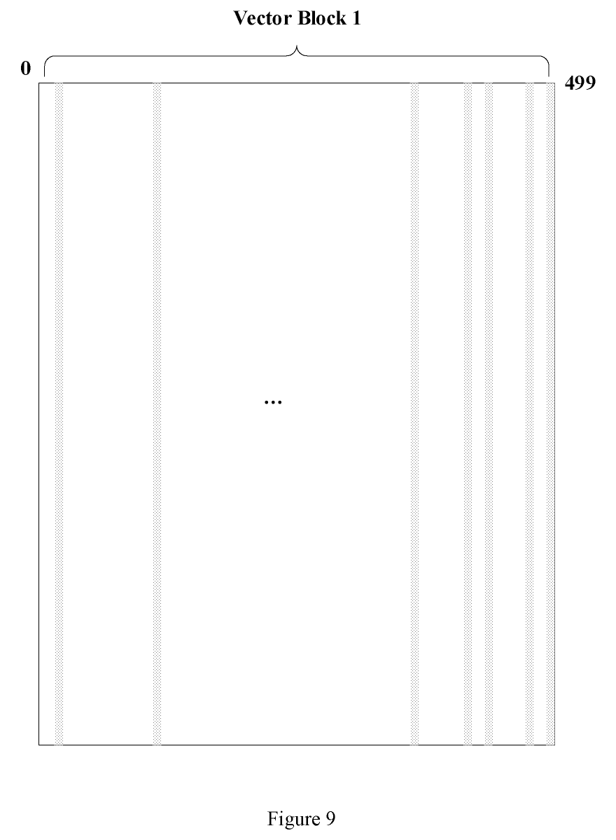

FIG. 9 illustrates a schematic diagram of another implementation scenario of a processing method consistent with the disclosed embodiments of the present disclosure. In one embodiment, as shown in FIG. 9, the quantity of vector pairs in Vector Block 1 is 500, and the sampling ratio is 40%. That is, 40% (200 vector pairs) needs to be sampled from vector block 1. The 200 vector pairs may be randomly sampled from the 500 vector pairs in Vector Block 1, for example, the vector pair at global temporal position t=10, ..., the vector pair at global temporal position t=400, the vector pair at global temporal position t=460, the vector pair at global temporal position t=469, the vector pair at global temporal position t=490, and the vector pair at global temporal position t=499. The 200 pairs selected are not limited solely to the 200 pairs with the closest temporal distances within the vector block.

In one embodiment, while preserving more vector pairs within the vector blocks that are temporally close to the current generation temporal position, random sampling is performed on the vector pairs within each vector block based on the sampling ratio of the corresponding vector block. As such, during the attention computation process, excessive reliance on vector pairs exhibiting high local correlation may be avoided. Accordingly, the risk of newly generated semantic units deviating from the central theme may be mitigated, and accuracy and logical coherence may be improved.

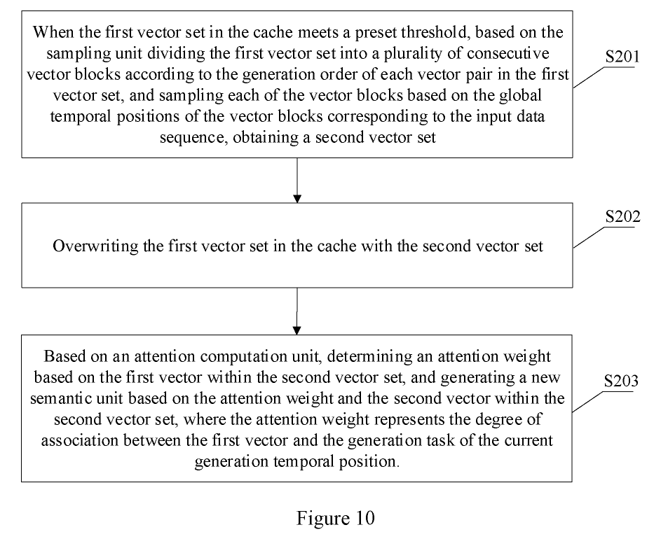

FIG. 10 illustrates a schematic flowchart of another processing method consistent with the disclosed embodiments of the present disclosure. As another optional embodiment of the present disclosure, referring to FIG. 10, the processing method may include, but is not limited to, S201, S202 and S203.

S201: when the first vector set in the cache meets a preset threshold, based on the sampling unit dividing the first vector set into a plurality of consecutive vector blocks according to the generation order of each vector pair in the first vector set, and sampling each of the vector blocks based on the global temporal positions of the vector blocks corresponding to the input data sequence, obtaining a second vector set.

The first vector set includes a plurality of vector pairs, and each vector pair includes a first vector and a second vector. The first vector is configured to identify the semantic unit within the input data sequence of the target model. The second vector is configured to characterize the semantics of the semantic unit. The closer the temporal distance between the global temporal position corresponding to a vector block and the current generation temporal position, the greater the quantity of vector pairs sampled from the vector block. The detailed procedure for S201 may be found in the relevant description of S101 in Embodiment 1, and will not be elaborated here.

S202: overwriting the first vector set in the cache with the second vector set. After overwriting the first vector set in the cache, only the second vector set remains in the cache, and the first vector set is deleted. As such, a portion of the cache space may be freed up and cache overhead may be reduced.

S203: based on an attention computation unit, determining an attention weight based on the first vector within the second vector set, and generating a new semantic unit based on the attention weight and the second vector within the second vector set. The attention weight represents the degree of association between the first vector and the generation task of the current generation temporal position. The detailed procedure for S203 may be found in the relevant description of S102 in Embodiment 1, and will not be elaborated here.

In one embodiment, the first vector set is sampled through S201 to obtain the second vector set. In the subsequent attention computation phase, only the sampled second vector set is used as the basis for calculation. As such, the quantity of the vector pairs involved in the calculation may be reduced, and the computational burden of the attention computation may be alleviated. Accordingly, the consumption of critical resources, such as main memory and video memory, may be reduced, and system operational pressure may be mitigated.

In addition, since S202 overwrites the first vector set in the cache with the second vector set, invalid data may be prevented from continuously occupying main memory and video memory. Accordingly, the utilization efficiency of system resources may be improved, providing robust support for the high-efficiency operation of AI models.

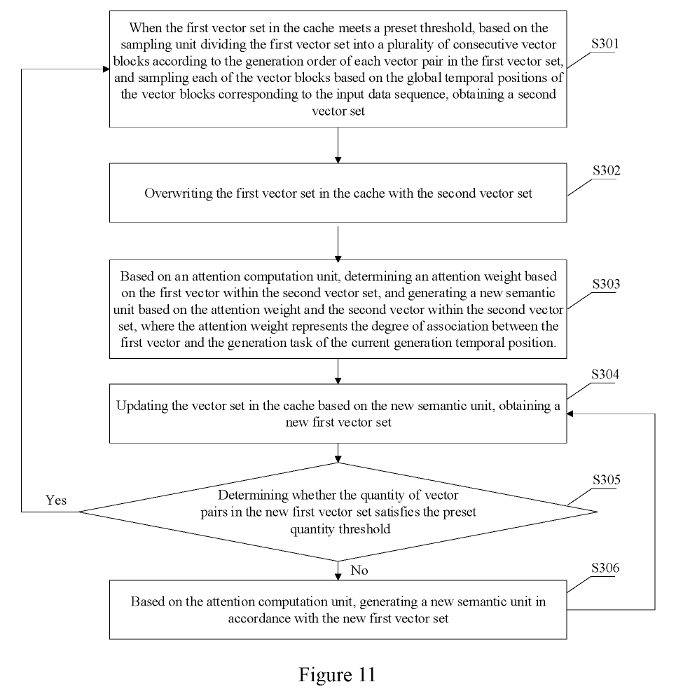

FIG. 11 illustrates a schematic flowchart of another processing method consistent with the disclosed embodiments of the present disclosure. As another optional embodiment of the present disclosure, referring to FIG. 11, the processing method may include, but is not limited to, S301-S306.

S301: when the quantity of vector pairs in the first vector set in the cache meets a preset threshold, based on the sampling unit dividing the first vector set into a plurality of consecutive vector blocks according to the generation order of each vector pair in the first vector set, and sampling each of the vector blocks based on the global temporal positions of the vector blocks corresponding to the input data sequence, obtaining a second vector set.

The first vector set includes a plurality of vector pairs, each including a first vector and a second vector. S301 provides an implementation approach for the scenario in which the quantity of vector pairs within the first vector set in the cache satisfies a preset quantity threshold. The quantity threshold may be set as needed and is not restricted in the present disclosure.

The first vector is configured to identify the semantic unit in the input data sequence of the target model. The second vector is configured to characterize the semantics of the semantic unit. The closer the temporal distance between the global temporal position corresponding to the vector block and the current generation temporal position, the greater the quantity of the vector pairs sampled from the vector block.

S302: overwriting the first vector set in the cache with the second vector set. After overwriting the first vector set in the cache, only the second vector set remains in the cache, and the first vector set is deleted, thereby reducing the video memory usage.

S303: based on an attention computation unit, determining an attention weight based on the first vector within the second vector set, and generating a new semantic unit based on the attention weight and the second vector within the second vector set. The attention weight represents the degree of association between the first vector and the generation task of the current generation temporal position.

For detailed procedure for S301–S303, reference may be made to in the relevant description of S201–S203 in Embodiment 7, and will not be elaborated here.

S304: updating the vector set in the cache based on the new semantic unit, thereby obtaining a new first vector set. In one embodiment, the new semantic unit may be processed based on an artificial intelligence model to generate a vector pair corresponding to the new semantic unit, and the new vector pair corresponding to the new semantic unit may be added to the first vector set in the cache. For example, the first vector set in the cache includes 660 vector pairs. After adding the vector pair corresponding to the new semantic unit to the first vector set in the cache, the new first vector set includes 661 vector pairs, that is, 661 vector pairs are stored in the cache.

S305: determining whether the quantity of vector pairs in the new first vector set satisfies the preset quantity threshold. The preset quantity threshold may be preset as needed and is not limited in the present disclosure. For example, the preset quantity threshold may be 2,000. When the quantity of vector pairs in the new first vector set satisfies the preset quantity threshold, S301 will be executed; when the quantity of vector pairs in the new first vector set does not satisfy the preset quantity threshold, S306 will be executed.

S306: based on the attention computation unit, generating a new semantic unit in accordance with the new first vector set, and continuously executing S304.

The process of, based on the attention computation unit, generating a new semantic unit in accordance with the new first vector set, is similar to the process of generating a new semantic unit based on the second vector set in S303, and will not be elaborated here.

As an example, in one embodiment, the preset quantity threshold is 2,000. At the current generation temporal position t=2000, the first vector set includes 2000 vector pairs. The first vector set is partitioned into four consecutive vector blocks, designated as Vector Block 1, Vector Block 2, Vector Block 3, and Vector Block 4, respectively. The global temporal position corresponding to Vector Block 1 is T0=0; the global temporal position corresponding to Vector Block 2 is T1=500; the global temporal position corresponding to Vector Block 3 is T2=1000; and the global temporal position corresponding to Vector Block 4 is T3=1500. The temporal distance between the global temporal position corresponding to Vector Block 4 and the current generation temporal position is the shortest. That is, the target vector block may be Vector Block 4.

Vector Block 1 includes vector pairs ranging from global temporal position t=0 to global temporal position t=499 (totaling 500 pairs); Vector Block 2 includes vector pairs ranging from global temporal position t=900 to global temporal position t=999 (totaling 500 pairs); Vector Block 3 includes vector pairs ranging from global temporal position t=1000 to global temporal position t=1499 (totaling 500 pairs); and Vector Block 4 includes vector pairs ranging from global temporal position t=1500 to global temporal position t=1999 (totaling 500 pairs).

Each of the 500 vector pairs in Vector Block 4 is sampled. For Vector Block 3, 100 vector pairs are sampled. For Vector Block 2, 50 vector pairs are sampled. For Vector Block 1, 10 vector pairs are sampled. Accordingly, the second vector set may include 660 vector pairs.

The second vector set with 660 vector pairs overwrites the first vector set with 2,000 vector pairs in the cache. Based on the attention computation unit, a new semantic unit may be generated from the 660 vector pairs. Subsequently, the vector set in the cache is updated based on the new semantic unit, yielding a new first vector set with 661 vector pairs.

The quantity of 661 vector pairs does not meet the requirement of 2,000. Based on the attention computation unit, a new semantic unit may be continuously generated based on the 661 vector pairs. Subsequently, the first vector set in the cache (i.e., the 661 vector pairs) may be updated based on the new semantic unit, yielding a new first vector set with 662 vector pairs.

The quantity of 662 vector pairs does not meet the requirement of 2,000. Based on the attention computation unit, a new semantic unit may be continuously generated based on the 662 vector pairs. Subsequently, the first vector set in the cache (i.e., the 662 vector pairs) is updated based on the new semantic unit, yielding a new first vector set with 663 vector pairs.

The quantity of vector pairs (663) does not meet the requirement of 2,000. Based on the attention computation unit, a new semantic unit may be continuously generated based on the 663 vector pairs. Subsequently, the first vector set in the cache (i.e., the 663 vector pairs) may be updated based on the new semantic unit, yielding a new first vector set with 664 vector pairs.

The above process may be repeated until the quantity of vector pairs in the cache reaches 2,000, and the sampling operation may be performed again. That is, based on the generation sequence of each vector pair in the new first vector set, the sampling unit may divide the new first vector set into a plurality of consecutive vector blocks. Then, based on the global temporal positions corresponding to the respective vector blocks in the input data sequence, each of the vector blocks may be sampled to obtain a second vector set.

From a time perspective, the whole processing flow may be divided into a data prefilling phase and a decoding phase. At different stages, as vector pairs are continuously generated, the quantity of vector pairs in the first vector set in the cache may steadily accumulate. The sampling operation may be dynamically triggered based on a preset quantity threshold.

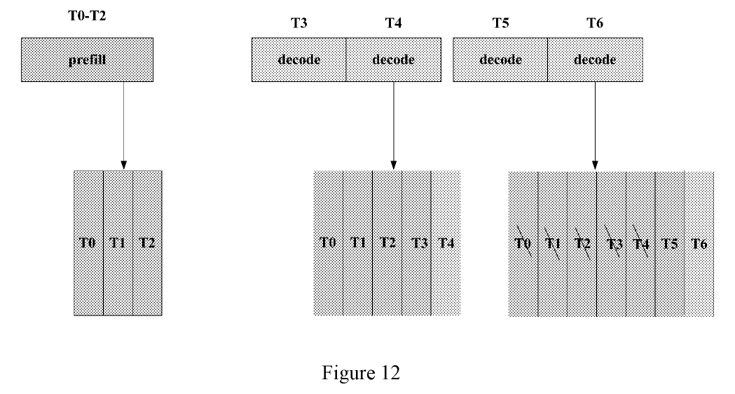

FIG. 12 illustrates a schematic diagram illustrating a time perspective of a processing method consistent with the disclosed embodiments of the present disclosure. In one embodiment, as shown in FIG. 12, during the prefilling phase, the input data sequence may be processed using an AI model to obtain vector pairs corresponding to each semantic unit. During this process, the time points T0, T1, and T2 are successively encountered. As the data corresponding to each time point is processed, vector pairs are continuously generated and stored in the cache, resulting in a first vector set. However, after passing through the three time points T0, T1, and T2, the quantity of vector pairs contained within the first vector set in the cache may not yet reach the preset threshold (e.g., 2,000). As such, no sampling operation is triggered.

Upon entering the decoding phase, the AI model continues to generate new semantic units based on the first vector set in the cache, and updates the vector set in the cache. The decoding phase may successively pass through time points T3 and T4. At time points T3 and T4, the sampling operation may still not be executed, for a same reason: the quantity of vector pairs within the first vector set in the cache does not yet reach the preset threshold. That is, throughout the entire process from T0 to T4, though the quantity of vector pairs in the cache gradually increases, each of the vector pairs generated from T0 up to the current time point is consistently retained. No sampling or pruning operations are performed, and each of the vector pairs in the cache participates in the attention computation.

As new semantic units are continuously generated, the quantity of vector pairs in the cache continues to accumulate. As time advanced from stage T5 to T6, the quantity of vector pairs in the first vector set in the cache may reach the preset threshold of 2,000. In this case, the sampling mechanism is triggered. Based on the sampling unit, and in accordance with the generation sequence of the vector pairs within the new first vector set, the new first vector set may be partitioned into a plurality of consecutive vector blocks. The vector pairs generated in stage T6 may be divided into vector block 4, the vector pairs generated in stages T4-T5 may be divided into vector block 3, the vector pairs generated in stage T3 may be divided into vector block 2, and the vector pairs generated in stages T0-T2 may be divided into vector block 1. The sampling ratio for Vector Block 4 may be 100%. However, for the vector pairs generated during stages T4–T5, T3, and T0–T2, since the temporal distance of the vector pairs from the current generation temporal position is relatively large, only a subset of the vector pairs may be retained during the sampling process.

It should be noted that, in FIG. 10, the deletion symbol “\” applied to stages T4–T5, T3, and T0–T2 merely indicates that the vector pairs generated at these stages are sampled rather than entirely deleted.

In one embodiment, when the quantity of vector pairs within the new first vector set does not meet the preset quantity threshold, sampling may not be triggered. Instead, a new semantic unit may be generated directly based on the new first vector set, thereby enhancing the efficiency of generating the new semantic unit. In addition, the first vector set may provide richer recent contextual information for the generation task. Accordingly, the accuracy and logical coherence of the new semantic unit may be improved.

As another optional embodiment of the present disclosure, Embodiment 8 may include, but is not limited to, S401-S405.

S401: obtaining an input data sequence. The input data sequence may be a serialized representation derived from various forms of data after preprocessing, such as text, speech, or images. For example, in a natural language processing task, the input data sequence typically includes text sequences composed of characters, words, phrases, and so on.

As an example, in a natural language processing scenario, the input data sequence is "I Love Natural Language Processing". An AI model may subsequently perform inference based on the input data sequence, progressively generating new semantic units to extend or interpret the input data sequence.

S402: based on an AI model, processing the input data sequence to obtain a first vector set.

S403: based on the generation order of each vector pair in the first vector set, dividing the first vector set into a plurality of consecutive vector blocks, and sampling each of the vector blocks based on the global temporal positions corresponding to the vector blocks within the input data sequence, thereby obtaining a second vector set. The closer the temporal distance between the global temporal position corresponding to the vector block and the current generation temporal position, the greater the quantity of vector pairs sampled from the vector block.

S404: based on the AI model, determining the attention weight based on the first vector within the second vector set, and generating a new semantic unit based on the attention weight and the second vector within the second vector set. The attention weight represents the degree of association between the first vector and the generation task of the current generation temporal position.

The detailed procedures for steps S402–S404 may be found in the relevant descriptions in Embodiment 1, and are not elaborated here.

S405: based on the AI model and the new semantic unit, obtaining a new input data sequence. In one embodiment, the new semantic unit generated may be added to the input data sequence, obtaining a new input data sequence. For example, given the input data sequence "I Love Natural Language Processing," and assuming that during the preceding inference process, following a series of processing operations applied to input data sequence (e.g., S402–S403), the AI model may generate a new semantic unit "Technology" based on the current generation task and the results of attention computation.

At this point, by appending the newly generated semantic unit "Technology" to the input data sequence "I Love Natural Language Processing", the new input data sequence may be "I Love Natural Language Processing Technology".

In one embodiment, the first vector set may be divided into a plurality of consecutive vector blocks according to the generation order of each vector pair in the first vector set. Then, based on the global temporal positions corresponding to the respective vector blocks in the input data sequence, each of the vector blocks is sampled to obtain a second vector set. During the sampling process, the closer the temporal distance between the global temporal position corresponding to a vector block and the current generation temporal position, the greater the quantity of vector pairs sampled from the vector block. In this way, the quantity of vector pairs in the second vector set may be smaller than the quantity of vector pairs in the first vector set, while the complete loss of local information may be prevented. In addition, the vector pairs in the vector blocks, which exhibit a close temporal distance to the current generation temporal position, may be retained to a greater extent.

Based on this, using an AI model, an attention weight may be determined according to the first vector in the second vector set, and a new semantic unit may be generated based on the attention weight and the second vector in the second vector set. As such, the computational cost of the attention computation may be reduced, thereby lowering main memory and video memory usage. In addition, the complete loss of local information may be avoided during the sampling process, and the occurrence of semantic discontinuity may be prevented during the attention computation process.

In addition, since more vector pairs are retained during the sampling phase for the vector blocks that are temporally closer to the current generation temporal position, the AI-based inference model may effectively capture local contextual information that has a greater impact on the generation task of the current generation temporal position. Accordingly, the new semantic unit generated at the current generation temporal position may have high accuracy, as well as logical coherence among the semantic units. As such, the accuracy of the new input data sequence may be preserved, and the potential precision loss that might otherwise result from sampling operations may be prevented.

The present disclosure also provides an electronic device. The electronic device may include a sampling unit and an attention computation unit.

The sampling unit is configured, when a first vector set in a cache satisfies a preset threshold, to partition the first vector set into a plurality of consecutive vector blocks based on the generation order of the respective vector pairs in the first vector set, and to sample each of the vector blocks based on the global temporal positions of the vector blocks corresponding to the input data sequence to obtain a second vector set. The first vector set includes a plurality of vector pairs, and each vector pair includes a first vector and a second vector. The first vector is configured to identify the semantic unit within the input data sequence of the target model. The second vector is configured to characterize the semantics of the semantic unit. The closer the temporal distance between the global temporal position corresponding to the vector block and the current generation temporal position, the greater the quantity of vector pairs sampled from the vector block.

The attention computation unit is configured to determine the attention weight based on the first vector in the second vector set, and to generate a new semantic unit based on the attention weight and the second vector in the second vector set. The attention weight represents the degree of association between the first vector and the generation task of the current generation temporal position.

In one embodiment, a process of the sampling unit sampling each of the vector blocks, based on the global temporal position corresponding to each of the vector blocks in the input data sequence, may specifically include: assigning an initial sampling ratio to the target vector block among the vector blocks that has the closest temporal distance to the current generation temporal position; as the difference between the global temporal position of each of the other vector blocks and the global temporal position of the target vector block increases, decreasing the sampling ratio for the other vector blocks, starting from the initial sampling ratio; and sampling each of the vector blocks based on the sampling ratio of each of the vector blocks.

In one embodiment, an operation of, as the difference between the global temporal position of each of the other vector blocks and the global temporal position of the target vector block increases, decreasing the sampling ratio for the other vector blocks, starting from the initial sampling ratio, may specifically include: as the difference between the global temporal position of each of the other vector blocks and the global temporal position of the target vector block increases, linearly decreasing the sampling ratio for the other vector blocks, starting from the initial sampling ratio.

In one embodiment, an operation of, as the difference between the global temporal position of each of the other vector blocks and the global temporal position of the target vector block increases, decreasing the sampling ratio for the other vector blocks, starting from the initial sampling ratio, may specifically include: as the difference between the global temporal position of each of the other vector blocks and the global temporal position of the target vector block increases, nonlinearly decreasing the sampling ratio for the other vector blocks, starting from the initial sampling ratio.

In one embodiment, an operation of the sampling unit sampling each of the vector blocks based on the sampling ratio of each of the vector blocks may specifically include: for each vector pair within each of the described vector blocks, determining the intra-block temporal distance between the global temporal position corresponding to the vector pair and the current generation temporal position; within a same vector block, by comparing the value of the intra-block temporal distance for each of the vector pairs, sampling the vector pairs at a preset sampling interval, starting with the vector pair with the minimum intra-block temporal distance, until the quantity of sampled vector pairs reaches the specified sampling ratio for the vector block.

In one embodiment, an operation of the sampling unit sampling each of the vector blocks based on the sampling ratio of each of the vector blocks may specifically include: based on the sampling ratios of the vector blocks, randomly sampling the vector pairs within each of the vector blocks.

In one embodiment, an operation of the sampling unit sampling each of the vector blocks based on the global temporal position corresponding to each of the vector blocks in the input data sequence, may also include: overwriting the first vector set in the cache with the second vector set.

The scenario, in which the first vector set in the cache meets a preset threshold, may include: a scenario in which the quantity of vector pairs within the first vector set in the cache satisfies a preset quantity threshold.

In one embodiment, after a process of generating the new semantic unit based on the attention weight and the second vector in the second vector set, the sampling unit may also be used to update the first vector set in the cache based on the new semantic unit, thereby obtaining a new first vector set.

When the quantity of vector pairs in the new first vector set meets the preset threshold, the sampling unit may continue to divide the first vector set into a plurality of consecutive vector blocks according to the generation order of each vector pair in the first vector set, and based on the global temporal positions corresponding to the respective vector blocks within the input data sequence, sample each of the vector blocks to obtain the second vector set.

When the quantity of vector pairs in the new first vector set does not meet the preset threshold, the attention computation unit may continue to generate a new semantic unit based on the new first vector set, and trigger the sampling unit to proceed with the process of updating the first vector set in the cache based on the new semantic unit, thereby obtaining a new first vector set.

It should be noted that the embodiments of the device described in the present disclosure are merely illustrative. The units described as separate components may or may not be physically distinct, and the components depicted as units may or may not constitute physical units, that is, the components may be situated in a single location or distributed across a plurality of network units. Depending on actual needs, a subset or each of the modules may be selected to achieve the objectives of the solution described in one embodiment. In addition, in the accompanying drawings illustrating the embodiments of the device provided in the present disclosure, the connection relationships between modules indicate the existence of communication connections between the modules. Specifically, the communication connections may be implemented as one or more communication buses or signal lines.

Based on the descriptions of the embodiments in the present disclosure, those skilled in the art may understand that the present disclosure may be implemented by means of software combined with necessary general-purpose hardware; alternatively, the present disclosure may be implemented through dedicated hardware, including application-specific integrated circuits (ASICs), dedicated CPUs, dedicated memory, dedicated components, and the like. Generally speaking, functions performed by a computer program may be implemented using corresponding hardware; moreover, the specific hardware structures configured to realize a same function may take a wide variety of forms - such as analog circuits, digital circuits, or specialized circuits. However, for the purposes of the present disclosure, implementation via a software program is, in most cases, the preferred embodiment. Based on this understanding, the technical solution of the present disclosure, in essence or the part that contributes to the prior art, may be embodied in the form of a software product. The computer software product may be stored on a readable storage medium, such as a computer floppy disk, USB flash drive, portable hard drive, ROM, RAM, magnetic disk, or optical disc, and may include a plurality of instructions configured to make a computing device (which may be a personal computer, training device, network device, etc.) to execute the methods described in the various embodiments of the present disclosure.

In the embodiments of the present disclosure, implementation may be affected wholly or partially through software, hardware, firmware, or any combination thereof. When implemented using software, implementation may be realized wholly or partially in a form of a computer program product.

The computer program product may include one or more computer instructions. When the computer program instructions are loaded onto and executed by a computer, the processes or functions described in the embodiments of the present disclosure may be performed, in whole or in part. The computer may be a general-purpose computer, a special-purpose computer, a computer network, or other programmable device. The computer instructions may be stored in a computer-readable storage medium or transmitted from one computer-readable storage medium to another. For example, the computer instructions may be transmitted from a website, computer, training device, or data center to another website, computer, training device, or data center via wired means (e.g., coaxial cable, optical fiber, Digital Subscriber Line (DSL)) or wireless means (e.g., infrared, radio, microwave, etc.)). The computer-readable storage medium may be any available medium capable of being stored by a computer, or a data storage device including an integration of one or more available media, such as a training device or a data center. The usable medium may be a magnetic medium (e.g., a floppy disk, hard disk, or magnetic tape), an optical medium (e.g., a DVD), or a semiconductor medium (e.g., a Solid State Disk (SSD)), and so on.

As disclosed, the technical solutions of the present disclosure have the following advantages.

In the processing method provided by the present disclosure, when the first vector set in the cache meets a preset threshold, based on the generation order of each vector pair in the first vector set, the sampling unit divides the first vector set into a plurality of consecutive vector blocks. Furthermore, based on the global temporal positions corresponding to the respective vector blocks within the input data sequence, the vector blocks each are sampled to obtain a second vector set. During the sampling process, the closer the temporal distance between the global temporal position corresponding to the vector block and the current generation temporal position, the greater the quantity of the vector pairs sampled from the vector block. In this way, the quantity of vector pairs in the second vector set may be smaller than the quantity of vector pairs in the first vector set, while the complete loss of local information may be prevented. In addition, the vector pairs within the vector blocks, which exhibit a close temporal distance to the current generation temporal position, may be retained to a greater extent.

For example, various embodiments of the present disclosure provide an apparatus. The apparatus includes a plurality of modules, and each module includes a plurality of units. The modules and the units may be implemented by processor(s), or alternatively, may be implemented by specific logic circuits. During implementation, the processor may be an artificial intelligence (AI) acceleration engine (e.g., a neural processing unit (NPU)), a graphics processing unit (GPU), a central processing unit (CPU), a microprocessor unit (MPU), a digital signal processor (DSP), a field programmable gate array (FPGA), or the like.

An electronic device may also be provided, including one or more processors and a memory storing instructions that, when being executed, cause the one or more processors to perform the methods disclosed herein. A non-transitory computer-readable storage medium may be provided, storing/containing instructions that, when being executed, cause at least one processor to perform the methods disclosed herein.

With the attention computation unit, the attention weight may be determined according to the first vector in the second vector set, and a new semantic unit may be generated based on the attention weight and the second vector in the second vector set. As such, the computational complexity of the attention computation may be reduced, and the main memory and video memory usage, as well as computation time may be lowered. Also, since the complete loss of local information may be avoided during the sampling process, the attention computation process may prevent the occurrence of semantic discontinuity.

In addition, since more vector pairs are retained during the sampling process for the vector block that is temporally close to the current generation temporal position, the attention computation process may capture local contextual information that has a greater impact on the generation task of the current generation temporal position. As such, the new semantic unit generated at the current generation temporal position may have high accuracy, as well as good logical coherence among the semantic units. Accordingly, the accuracy of the inference process may be maintained, and potential precision loss that may arise from sampling operations may be prevented.

The embodiments disclosed in the present disclosure are exemplary only and not limiting the scope of the present disclosure. Various combinations, alternations, modifications, or equivalents to the technical solutions of the disclosed embodiments may be obvious to those skilled in the art and may be included in the present disclosure. Without departing from the spirit of the present disclosure, the technical solutions of the present disclosure may be implemented by other embodiments, and such other embodiments are intended to be encompassed within the scope of the present disclosure.

What is claimed is:

1. A processing method, comprising:
when a first vector set in a cache satisfies a preset threshold, partitioning, by a sampling unit, the first vector set into a plurality of consecutive vector blocks, based on a generation order of each vector pair in the first vector set, and sampling, by the sampling unit, each vector block of the plurality of consecutive vector blocks to obtain a second vector set, based on a global temporal position of each vector block of the plurality of consecutive vector blocks within an input data sequence of a target model, wherein the first vector set include a plurality of vector pairs, a vector pair of the plurality of vector pairs includes a first vector and a second vector, the first vector is configured to identify a semantic unit within the input data sequence of the target model, the second vector is configured to characterize semantics of the semantic unit, and the closer a temporal distance between the global temporal position corresponding to a vector block of the plurality of vector blocks and a current generation temporal position, the greater a quantity of vector pairs sampled from the vector block; and
determining, by an attention computation unit, an attention weight based on the first vector within the second vector set, and generating, by the attention computation unit, a new semantic unit based on the attention weight and the second vector within the second vector set, wherein the attention weight represents a degree of association between the first vector and a generation task of the current generation temporal position.

2. The method according to claim 1, wherein an operation of sampling each vector block of the plurality of consecutive vector blocks based on the global temporal position of each vector block of the plurality of consecutive vector blocks within the input data sequence, includes:
assigning an initial sampling ratio to a target vector block among the plurality of consecutive vector blocks, which has the closest temporal distance between the global temporal position and the current generation temporal position;
as difference between the global temporal positions of the target vector block and each of other vector blocks of the plurality of consecutive vector blocks increases, obtaining a sampling ratio for each of the other vector blocks by decreasing from the initial sampling ratio; and
sampling each of the plurality of consecutive vector blocks based on the sampling ratio of each of the plurality of consecutive vector blocks.

3. The method according to claim 2, wherein an operation of, as the difference between the global temporal positions of the target vector block and each of other vector blocks of the plurality of consecutive vector blocks increases, obtaining the sampling ratio for each of the other vector blocks by decreasing from the initial sampling ratio, includes:
as the difference between the global temporal positions of the target vector block and each of other vector blocks of the plurality of consecutive vector blocks increases, linearly decreasing from the initial sampling ratio.

4. The method according to claim 2, wherein an operation of, as the difference between the global temporal positions of the target vector block and each of other vector blocks of the plurality of consecutive vector blocks increases, obtaining the sampling ratio for each of the other vector blocks by decreasing from the initial sampling ratio, includes:
as the difference between the global temporal positions of the target vector block and each of other vector blocks of the plurality of consecutive vector blocks increases, non-linearly decreasing from the initial sampling ratio.

5. The method according to claim 2, wherein an operation of sampling each of the plurality of consecutive vector blocks based on the sampling ratio of each of the plurality of consecutive vector blocks includes:
determining, for each vector pair of the vector pairs within each of the vector blocks, an intra-block temporal distance between the global temporal position corresponding to the vector pair and the current generation temporal position; and
within a same vector block of the plurality of consecutive vector blocks, by comparing the intra-block temporal distance for each vector pair of the vector pairs, performing sampling, starting from the vector pair with a minimum intra-block temporal distance, at a preset sampling interval, until a quantity of the vector pairs sampled reaches a specified sampling ratio for the vector block.

6. The method according to claim 2, wherein an operation of sampling each of the plurality of consecutive vector blocks based on the sampling ratio of each of the plurality of consecutive vector blocks includes:
based on the sampling ratio of each of the plurality of consecutive vector blocks, randomly sampling vector pairs within each of the vector blocks.

7. The method according to claim 1, after sampling each vector block of the plurality of consecutive vector blocks to obtain the second vector set, based on the global temporal position of each vector block of the plurality of consecutive vector blocks within the input data sequence, further comprising:
overwriting the first vector set in the cache with the second vector set.

8. The method according to claim 7, wherein:
a scenario in which the first vector set in the cache satisfies the preset threshold, includes a scenario in which a quantity of the vector pairs within the first vector set in the cache satisfies a preset quantity threshold; and
after generating the new semantic unit based on the attention weight and the second vector within the second vector set, the method further comprises:
updating the first vector set in the cache based on the new semantic unit, obtaining a new first vector set;
when a quantity of the vector pairs in the new first vector set satisfies the preset threshold, continuing operations of partitioning, by the sampling unit, the new first vector set into a plurality of consecutive vector blocks, based on the generation sequence of each vector pair in the new first vector set, and sampling, by the sampling unit, each vector block of the plurality of consecutive vector blocks to obtain a second vector set, based on the global temporal position of each vector block of the plurality of consecutive vector blocks within the input data sequence; and
when the quantity of vector pairs in the new first vector set does not satisfy the preset threshold, continuing operations of generating, by the attention computation unit, a new semantic unit based on the new first vector set, and updating the first vector set in the cache based on the new semantic unit to obtain a new first vector set.

9. An electronic device comprising:
one or more processors; and a memory storing instructions that, when being executed, cause the one or more processors to perform:
when a first vector set in a cache satisfies a preset threshold, partitioning, by a sampling unit, the first vector set into a plurality of consecutive vector blocks, based on a generation order of each vector pair in the first vector set, and sampling, by the sampling unit, each vector block of the plurality of consecutive vector blocks to obtain a second vector set, based on a global temporal position of each vector block of the plurality of consecutive vector blocks within an input data sequence of a target model, wherein the first vector set include a plurality of vector pairs, a vector pair of the plurality of vector pairs includes a first vector and a second vector, the first vector is configured to identify a semantic unit within the input data sequence of the target model, the second vector is configured to characterize semantics of the semantic unit, and the closer a temporal distance between the global temporal position corresponding to a vector block of the plurality of vector blocks and a current generation temporal position, the greater a quantity of vector pairs sampled from the vector block; and
determining, by an attention computation unit, an attention weight based on the first vector within the second vector set, and generating, by the attention computation unit, a new semantic unit based on the attention weight and the second vector within the second vector set, wherein the attention weight represents a degree of association between the first vector and a generation task of the current generation temporal position.

10. The device according to claim 9, wherein the one or more processors are further configured to perform:
assigning an initial sampling ratio to a target vector block among the plurality of consecutive vector blocks, which has the closest temporal distance between the global temporal position and the current generation temporal position;
as difference between the global temporal positions of the target vector block and each of other vector blocks of the plurality of consecutive vector blocks increases, obtaining a sampling ratio for each of the other vector blocks by decreasing from the initial sampling ratio; and
sampling each of the plurality of consecutive vector blocks based on the sampling ratio of each of the plurality of consecutive vector blocks.

11. The device according to claim 10, wherein the one or more processors are further configured to perform:
as the difference between the global temporal positions of the target vector block and each of other vector blocks of the plurality of consecutive vector blocks increases, linearly decreasing from the initial sampling ratio.

12. The device according to claim 10, wherein the one or more processors are further configured to perform:
as the difference between the global temporal positions of the target vector block and each of other vector blocks of the plurality of consecutive vector blocks increases, non-linearly decreasing from the initial sampling ratio.

13. The device according to claim 10, wherein the one or more processors are further configured to perform:
determining, for each vector pair of the vector pairs within each of the vector blocks, an intra-block temporal distance between the global temporal position corresponding to the vector pair and the current generation temporal position; and
within a same vector block of the plurality of consecutive vector blocks, by comparing the intra-block temporal distance for each vector pair of the vector pairs, performing sampling, starting from the vector pair with a minimum intra-block temporal distance, at a preset sampling interval, until a quantity of the vector pairs sampled reaches a specified sampling ratio for the vector block.

14. The device according to claim 10, wherein the one or more processors are further configured to perform:
based on the sampling ratio of each of the plurality of consecutive vector blocks, randomly sampling vector pairs within each of the vector blocks.

15. The device according to claim 9, wherein the one or more processors are further configured to perform:
overwriting the first vector set in the cache with the second vector set.

16. The device according to claim 15, wherein:
a scenario in which the first vector set in the cache satisfies the preset threshold, includes a scenario in which a quantity of the vector pairs within the first vector set in the cache satisfies a preset quantity threshold; and
the one or more processors are further configured to perform:
updating the first vector set in the cache based on the new semantic unit, obtaining a new first vector set;
when a quantity of the vector pairs in the new first vector set satisfies the preset threshold, continuing operations of partitioning, by the sampling unit, the new first vector set into a plurality of consecutive vector blocks, based on the generation sequence of each vector pair in the new first vector set, and sampling, by the sampling unit, each vector block of the plurality of consecutive vector blocks to obtain a second vector set, based on the global temporal position of each vector block of the plurality of consecutive vector blocks within the input data sequence; and
when the quantity of vector pairs in the new first vector set does not satisfy the preset threshold, continuing operations of generating, by the attention computation unit, a new semantic unit based on the new first vector set, and updating the first vector set in the cache based on the new semantic unit to obtain a new first vector set.

17. A non-transitory computer-readable storage medium storing instructions that, when being executed, cause at least one processor to perform the method according to claim 1.

18. An artificial intelligence model inference method, comprising:
obtaining an input data sequence;
based on an artificial intelligence model, processing the input data sequence to obtain a first vector set, wherein the first vector set includes a plurality of vector pairs, and a vector pair of the plurality of vector pairs includes a first vector and a second vector;
based on a generation order of each vector pair of the plurality of vector pairs in the first vector set, partitioning the first vector set into a plurality of consecutive vector blocks, and sampling each of the plurality of consecutive vector blocks based on global temporal positions corresponding to the plurality of consecutive vector blocks within the input data sequence to obtain a second vector set, wherein the closer a temporal distance between a global temporal position corresponding to a vector block of the plurality of consecutive vector blocks and a current generation temporal position, the greater a quantity of vector pairs sampled from the vector block;
based on the artificial intelligence model, determining an attention weight based on the first vector within the second vector set, and generating a new semantic unit based on the attention weight and the second vector within the second vector set, wherein the attention weight represents a degree of association between the first vector and a generation task of the current generation temporal position; and
based on the artificial intelligence model and the new semantic unit, obtaining a new input data sequence.

19. An electronic device comprising one or more processors and a memory storing instructions that, when being executed, cause the one or more processors to perform the method according to claim 18.

20. A non-transitory computer-readable storage medium storing instructions that, when being executed, cause at least one processor to perform the method according to claim 18.
